(19) United States
(12) Patent Application Publication
(10) Pub. No.: US 2002/0062355 A1
(43) Pub. Date: May 23, 2002

(54) Distributed communication system

(76) Inventors: Volker Luegger, Froendenberg (DE); Rainer Uecker, Muelheim (DE); Ralf Neuhaus, Luenen (DE)

Correspondence Address: BELL, BOYD & LLOYD, LLC, P. O. BOX 1135, CHICAGO, IL, 60690-1135, US

(21) Appl. No.: 09/955,516

(22) Filed: Sep. 18, 2001

(30) Foreign Application Priority Data
Sep. 19, 2000 (DE) 100 46 313.4

(51) Int. Cl. G06F 15/167

(52) U.S. Cl. 709/213

(57) ABSTRACT

A distributed communication system consisting of at least one communication device, preferably a private communication installation, and at least one central data processing device which are connected to one another via a network, preferably an IP-oriented network, wherein the central data processing device executes at least one communication application, and a central database for storing overlapping data, which are accessed by at least one communication device and/or at least one communication application, is arranged in the communication system.

### BACKGROUND OF THE INVENTION

Modern communication systems frequently consist of a number of interconnected communication installations distributed in space. Each of these communication installations has its own switching intelligence and its own local database for storing communication-installation-specific data. The local communication-installation-specific databases are used for storing data necessary for stand-alone operation of a communication installation; for example, subscriber numbers, authorizations, exchange lines, direct-dialing numbers, directory numbers, configuration data, short code dialing destinations etc. To implement a network interconnection of networked communication installations from these communication installations, the individual communication installations must be correspondingly configured in each case separately; i.e., aligned with the data stored in the other communication installations.

To expand the functionality, a central data processing device, frequently called server in the literature, can be provided within the communication system, via which additional communication applications are implemented. The server and the communication installations are connected to one another via a network via which bidirectional data transfer is achieved. Examples of such an expansion of the range of functions of a communication system are ACD (Automatic Call Distribution) solutions, call center, hotel or CTI (Computer Telephony Integration) applications.

In addition to the local databases of the communication installations, the server, as a rule, also has its own server-specific database in which the data relevant to the sequence of the respective application implemented in the server are stored. In the case of a call center application, these are, e.g., information items on the names and directory numbers of the individual call center agents.

In this connection it frequently occurs that certain data such as; e.g., the name and directory number of a subscriber, are needed by a number of devices within the communication system, by communication installations and/or the server. In the text which follows, such data are called overlapping data. In the solution according to the prior art, these overlapping data must be changed for this purpose both in the local databases of the respective communication installations and in the database of the server for every application.

Considering then the multiplicity of different communication applications and installations, changed data must be updated at a multiplicity of places within the communication system. One disadvantage of this solution consists in that care and maintenance of the databases are very expensive and subject to errors due to the quantity of data to be administered. In addition, it may happen that wrong data are input in the case of manual administration of the communication installations.

From WO 93/17515, a method “area wide Centrex” is already known in which a number of communication installations are arranged in a communication network. In the communication network, a central database is also provided in which subscriber-specific data of subscribers are stored which can be connected to different communication installations. These subscribers form a user group which appears to internal and external callers as if all subscribers of the user group are connected to a single communication installation. For this purpose, it is determined during the connection setup within this user group via a local database of the communication installation of the calling subscriber, in which the subscriber-specific data of all local subscribers are stored, whether the called subscriber is connected to the same communication installation. If this is so, the call is switched through by an internal connection within this communication installation. If the called subscriber is not registered in the local database, an enquiry is sent to the central database in which subscriber-specific data of all subscribers of the user group are stored, which transmits the data needed for the connection setup to the communication installation of the calling subscriber. The same enquiry is made to the central database if an external call for a subscriber of the user group cannot be switched within the communication installation.

Thus, the subscriber-specific data of the subscribers connected locally are registered in the local database of each communication installation. The central database also contains subscriber-specific data of all subscribers of the user group. These subscriber-specific data are a copy of the corresponding data from the local databases. The central database also contains data which define the communication relations between the subscribers of the higher-level user group.

The disadvantage of this solution consists in that identical subscriber-specific data must be available at a number of places. The prerequisite for disturbance-free operation is the consistency of the data which, on the one hand, are carried locally in the databases of the communication facilities and, on the other hand, are stored in parallel in the central database. Thus, changes of subscriber-specific data must always be performed in at least two databases.

Furthermore, a method called Regional CENTREX is known from U.S. Pat. No. 5,920,619 A, in which closed user groups are formed with a number of communication installations beyond the boundaries of an individual communication installation in a public communication network. The subscribers in each user group can reach other subscribers of the same group by using an internal directory number, even if these subscribers are connected to another remote communication installation. Each communication installation at which at least one subscriber of the closed user group is registered contains a database in which subscriber-specific data of all subscribers of the same user group are registered and in which an unambiguous external directory number, which is used for connection via the public communication network, is allocated to each subscriber in addition to the internal directory number. In the case of calls which go beyond an individual communication installation, the internal directory number is translated into the associated external directory number via this database and, conversely, a translation of the external directory number into the internal directory number is performed in the case of incoming calls from the closed user group.

Furthermore, a similar method to that disclosed in U.S. Pat. No. 5,920,619 A is known from DE 43 29 172 A1. This describes a communication network which consists of a central service computer and a number of communication installations in a public network. The central service computer contains a central database which includes all the data which are necessary for establishing a virtual private network. These data include, on the one hand, data which define the communication relation of the subscribers to one another, for example a private numbering plan, and, on the other hand, a copy of all subscriber-specific data of the respective subscribers from the local databases of the individual communication installations. The central service computer switches both internal calls to one another and external calls to internal subscribers via the stored information.

It is an object of the present invention to simplify the changing of overlapping data and, at the same time, ensure disturbance-free operation of the communication system.

### SUMMARY OF THE INVENTION

According to the present invention, overlapping data; i.e., data which are accessed by a number of units, communication installations and/or communication applications running on data processing devices, are stored in a central database.

An advantage of the present invention is, among other things, that overlapping data which are needed at a number of places in the communication system now need to be administered only centrally at one place; i.e., in the central database. If data are changed in this central database, they are immediately available for all authorized communication installations and communication applications after this change.

As an alternative, the central database can be implemented in a central data processing device, called server in the text which follows, or in a communication installation.

If the central database is implemented in a communication installation, access from outside; i.e., originating from the server or from another communication installation, is made possible by a local access device provided in the communication installation.

In this case, the server has a central access device via which authorized communication applications running on the server can access the overlapping data stored in the central database of the communication installation. If there are more communication installations in the communication system, these can access the central database of the corresponding communication installation via their own local access device.

If, as an alternative, the central database is implemented in the server, the access from outside; i.e., originating from a communication installation, is also made possible by a central access device implemented in the server.

In this case, the communication installations also in each case have a local access device for access to the central database of the server, via which access device the communication installations can access the overlapping data of the central database of the server.

The access from outside to the central database is achieved, for example, by a so-called encapsulation of the central database. Object-oriented programming provides special access functions for access to the data stored in the central database for each authorized unit of the communication system; i.e., for each communication installation and communication application, via the technique of encapsulation.

In addition, the server and the communication installations can have a local database in each case. In these local databases, local data are stored; i.e., data which are only needed for operating the server or the respective communication installation.

The preferably private communication system considered does not necessarily contain a server for implementing communication applications. As an alternative, a configuration is also possible in which there are only a number of mutually networked communication installations. In this case, the central database is implemented in one of the communication installations, a mechanism for access of the other communication installations to the central database being implemented in the corresponding communication installation.

Additional features and advantages of the present invention are described in, and will be apparent from, the following Detailed Description of the Invention and the Figures.

### BRIEF DESCRIPTION OF THE FIGURES

FIG. 1 shows a structural pattern for the diagrammatic representation of a communication system according to the present invention with a central database implemented in a server.

FIG. 2 shows a structural pattern for the diagrammatic representation of the communication system according to the present invention with a central database implemented in a communication installation.

### DETAILED DESCRIPTION OF THE INVENTION

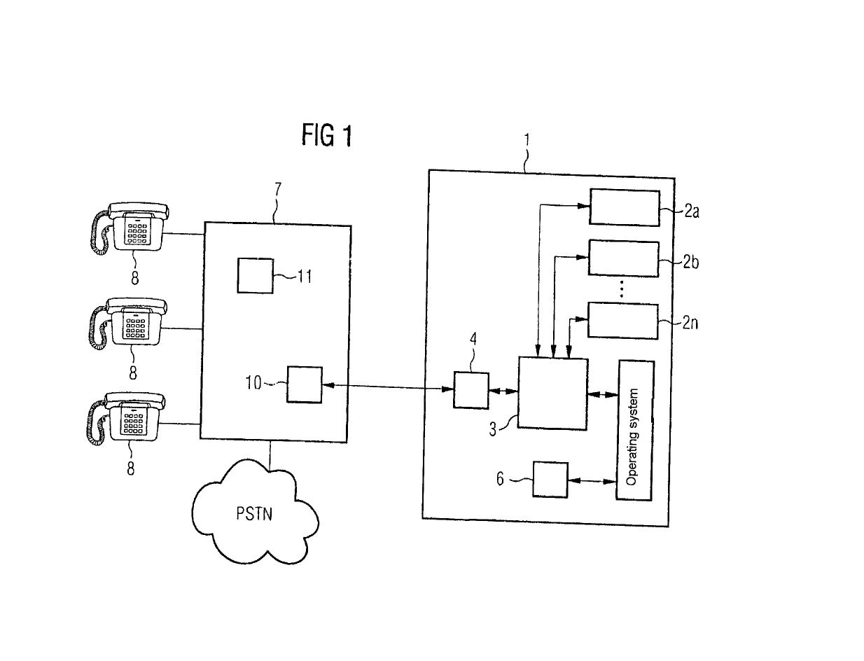

FIG. 1 shows a diagrammatic representation of a communication system consisting of a communication installation 7 and a server 1 connected to the communication installation. The communication installation 7 is used for connecting terminals 8, for example telephones or data processing devices, to the communication system. Furthermore, the communication installation 7 has a connection to a public switched telephone network (PSTN). As an alternative, a number of communication installations which are connected to one another via a network (not shown) and to servers, can be arranged in the communication system.

On the server 1, a number of communication applications 2a, . . ., 2n, are running; e.g., call center applications, text-to-speech applications or ACD applications. The server 1 is controlled by an operating system (e.g., Windows NT) which, among other things, controls the sequence of communication applications 2a, . . ., 2n and controls access to local or overlapping data of the communication system.

In the present exemplary embodiment, a central database 3 of the communication system is implemented in the server 1. The central database 3 is used for storing overlapping data. Overlapping data are understood to be data which are accessed by a number of units of the communication system; i.e., originating from a communication installation 7 and/or from a communication application 2a, . . ., 2n running on the server 1.

Access to the central database 3 by the communication installation 7 is made possible by a first central access device 4 in the server 1 or by a first local access device 10 in the communication installation 7.

In addition to the central database 3, the server 1 has a local database 6. Server-specific data; i.e., data which are exclusively needed for operating the server 1, are preferably stored in the local database 6. The communication installation 7 also has a local database 11 for storing communication-installation-specific data; i.e., data which are exclusively needed for operating the communication installation 7.

The server 1 and the communication installation 7 are connected to one another, for example, via an Ethernet LAN (Local Area Network) (not shown). In this arrangement, the overlapping data are bidirectionally transmitted via the network. Furthermore, a bidirectional transmission of voice data takes place via this network in the case where there are a number of networked communication installations or where there are corresponding communication applications 2a, . . ., 2n implemented in the server 1.

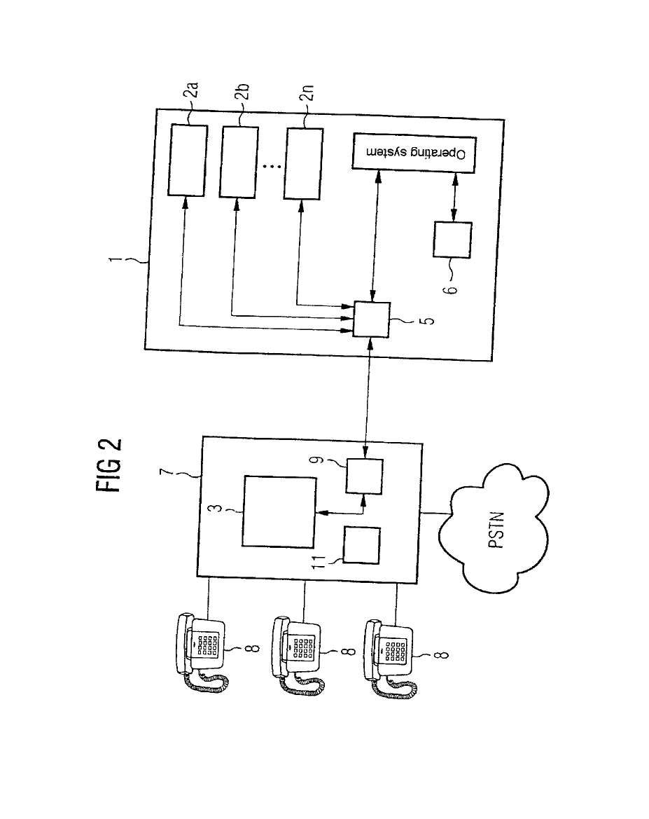

FIG. 2 shows another exemplary embodiment of the present invention in which, in contrast to the first exemplary embodiment, the central database 3 of the communication system is implemented in the communication installation 7.

In this case, access to the central database 3 is achieved from outside; i.e., for example by the server 1 or by another communication installation 7 (not shown) within the communication system, via a second local access device 9 in the communication system 7. In addition, the server 1 has a second central access device 5 which controls access to the central database 3 originating from a communication application 2a, . . ., 2n running on the server 1. Access to the central database 3 originating from one or more other communication installations 7 (not shown) takes place via the first local access devices 10 in each case implemented in the communication installations 7.

According to the present invention, all data needed in an overlapping manner are stored, maintained and administered in the central database 3 within the communication system.

The central database 3 contains an interface, the first central access device 4 according to the first exemplary embodiment or, respectively, the second local access device 9 according to the second exemplary embodiment, via which access from outside to certain data or data areas, which are relevant in an overlapping manner, is made possible.

For this purpose, the database can be encapsulated as COM, Active-X or as CORBA object. Special access functions are available via the encapsulation for accessing the central database 3. Each authorized unit; i.e., both communication installations and communication applications in the present invention, can directly access the central database 3 via this interface; i.e., read the desired data, change them or use them for further processing.

Due to the encapsulation of the central database 3 and the access facilities via the network within the communication system, it is of no significance whether a database encapsulated in this manner is implemented in a communication installation 7 or in a server 1. As soon as data are changed in the encapsulated central database 3, these are immediately available both to the respective communication installations 7 and the individual communication applications 2a, . . . 2n without further actions.

Although the present invention has been described with reference to specific embodiments, those of skill in the art will recognize that changes may be made thereto without departing from the spirit and scope of the invention as set forth in the hereafter appended claims.

1. A communication system, comprising at least one communication device and at least one central data processing device, the at least one communication device being connected to the at least one central data processing device via a network, wherein the at least one central data processing device executes at least one communication application, overlapping data being provided which are accessed by at least one of the at least one communication device and the at least one communication application, and wherein at least some of the overlapping data are stored at one place in the communication system which is accessed by the at least one communication device and the at least one communication application or at least two communication devices.

2. A communication system as claimed in claim 1, wherein the overlapping data are stored in a central database.

3. A communication system as claimed in claim 2, wherein all overlapping data are stored in the central database and each communication device and each communication application access the central database when utilizing the overlapping data.

4. A communication system as claimed in claim 2, wherein the central database is implemented in the at least one central data processing device.

5. A communication system as claimed in claim 4, wherein a first central access device for controlling access from outside the data processing device to the central database is provided in the at least one central data processing device.

6. A communication system as claimed in claim 4, wherein a first local access device for controlling access of the communication device to the central database is provided in the at least one communication device.

7. A communication system as claimed in claim 2, wherein the central database is implemented in the at least one communication device.

8. A communication system as claimed in claim 7, wherein a second central access device for controlling access of a communication application to the central database is provided in the at least one central data processing device.

9. A communication system as claimed in claim 7, wherein a second local access device for controlling access from outside the communication device to the central database is provided in the at least one communication device.

10. A communication system as claimed in claim 2, wherein the central database is encapsulated.

11. A communication system as claimed in claim 2, wherein a local database for storing data which exclusively relate to operation of the data processing device is implemented in the at least one central data processing device.

12. A communication system as claimed in claim 2, wherein a local database for storing data which exclusively relate to operation of the communication device is implemented in the at least one communication device.

13. A communication system as claimed in claim 1, wherein the network is an IP-oriented network.

14. A communication system as claimed in claim 1, wherein the communication device is a private communication installation.
